(19) United States
(12) Patent Application Publication
(10) Pub. No.: US 2024/0166407 A1
(43) Pub. Date: May 23, 2024

(54) SMART MATERIAL STORAGE CONTAINER FOR MANUFACTURING MATERIALS

(71) Applicant: Micron Technology, Inc., Boise, ID (US)

(72) Inventor: Yen-Ee New, Muar (MY)

(21) Appl. No.: 18/510,277

(22) Filed: Nov. 15, 2023

Related U.S. Application Data
(60) Provisional application No. 63/384,216, filed on Nov. 17, 2022.

(51) Int. Cl. B65D 25/04

(52) U.S. Cl. CPC B65D 25/04

(57) ABSTRACT

Methods, systems, and devices for smart material storage container for manufacturing materials are described. A material storage container may receive, from a user, a manufacturing lot identifier for manufacturing a part. The material storage container may determine a manufacturing material for manufacturing the part associated with the manufacturing lot identifier. The material storage container may select, from a set of storage compartments that store different manufacturing materials, a storage compartment with the manufacturing material for withdrawal based on one or more criteria. The material storage container may indicate the storage compartment with the manufacturing material for withdrawal.

### CROSS REFERENCE

The present application for patent claims priority to and the benefit of U.S. Provisional Patent Application No. 63/384,216 by New et al., entitled “SMART MATERIAL STORAGE CONTAINER FOR MANUFACTURING MATERIALS,” filed Nov. 17, 2023, assigned to the assignee hereof, and is expressly incorporated by reference in its entirety herein.

### FIELD OF TECHNOLOGY

The following relates to one or more systems for memory, including a smart material storage container for manufacturing materials.

### BACKGROUND

A manufacturing facility may use a variety of manufacturing materials to manufacture various devices, such as electronic devices. Improved techniques for storing and managing manufacturing materials may be desired.

### BRIEF DESCRIPTION OF THE DRAWINGS

FIG. 1 illustrates an example of a smart material storage container for manufacturing materials in accordance with examples as disclosed herein.

FIG. 2 illustrates an example of a system that supports a smart material storage container for manufacturing materials in accordance with examples as disclosed herein.

FIG. 3 illustrates an example of a process flow that supports a smart material storage container for manufacturing materials in accordance with examples as disclosed herein.

FIG. 4 illustrates an example of a process flow that supports a smart material storage container for manufacturing materials in accordance with examples as disclosed herein.

FIG. 5 illustrates a block diagram of a material storage container for manufacturing materials in accordance with examples as disclosed herein.

FIG. 6 illustrates a flowchart showing a method or methods that support a smart material storage container for manufacturing materials in accordance with examples as disclosed herein.

### DETAILED DESCRIPTION

A variety of manufacturing materials may be used to manufacture different devices, such as electronic devices. For example, a device may include multiple parts, each of which includes one or more manufacturing materials. To enable efficient production of devices, a manufacturing facility may store (e.g., on premises) the manufacturing materials used to manufacture the devices. Current techniques for storing and managing manufacturing materials may be costly and inefficient, among other drawbacks. Improved techniques for storing and managing manufacturing materials may be desired.

The present disclosure provides a smart material storage container and system for storing and managing manufacturing materials. The material storage container may be configured to limit access to manufacturing materials to authorized users and to assist users in withdrawing the correct manufacturing materials for a given part or process step. The material storage container may also facilitate the replenishment of manufacturing materials and the disposal of manufacturing materials. In some examples, a system (e.g., a server) may interact with a network of material storage containers and assist in the operations of the material storage containers as well as manage inventory for the manufacturing materials.

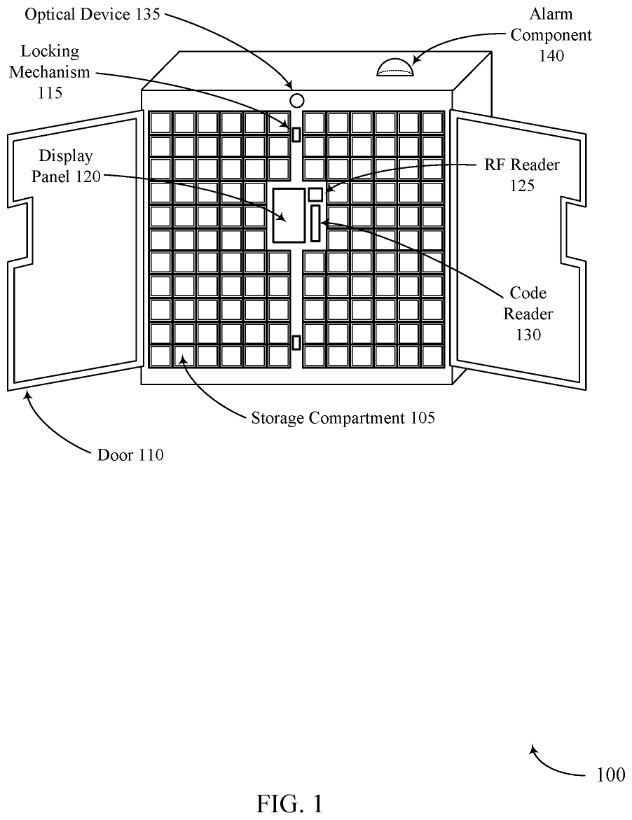

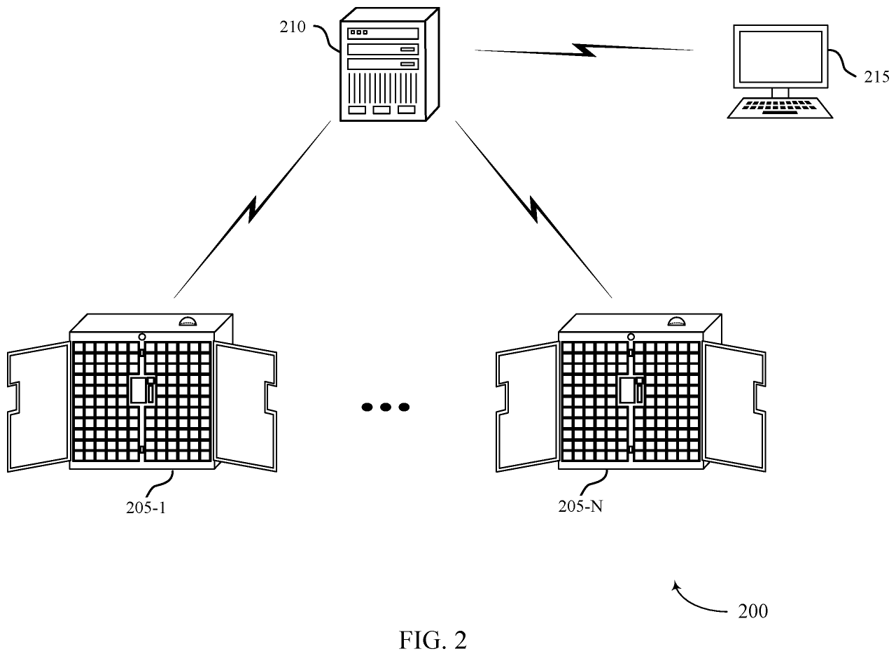

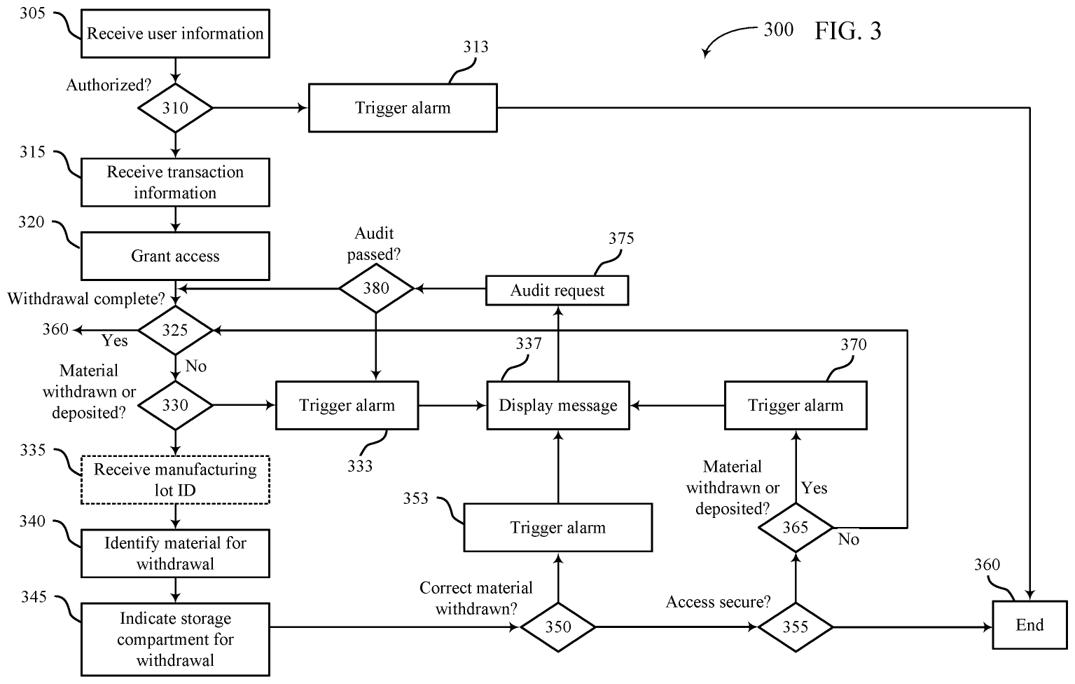

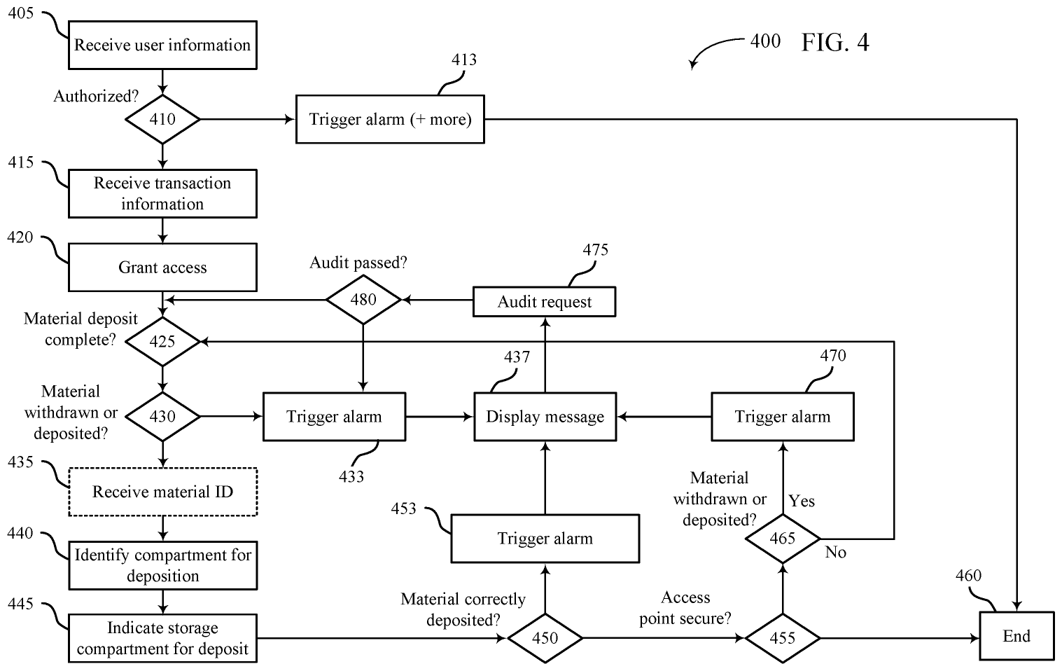

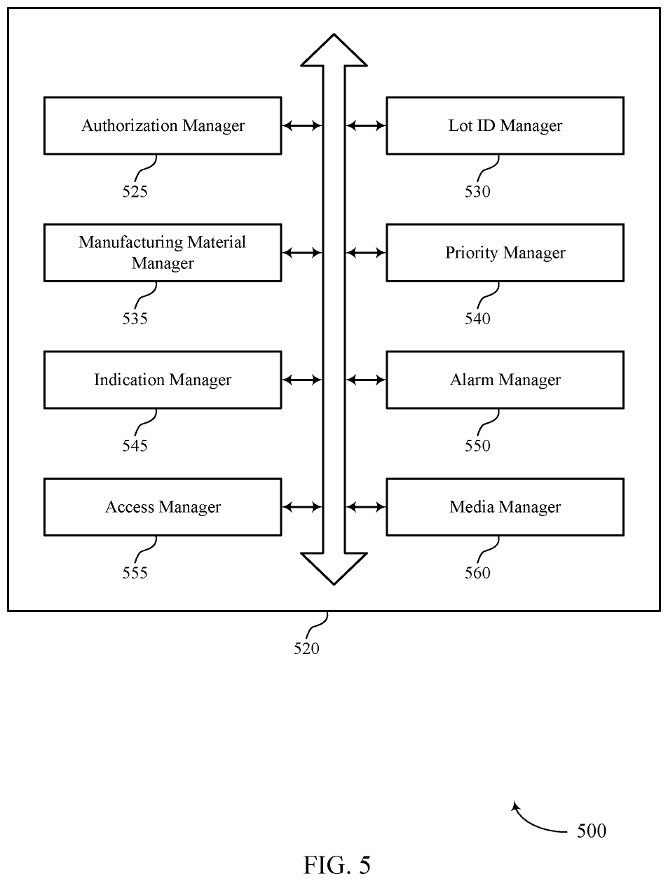

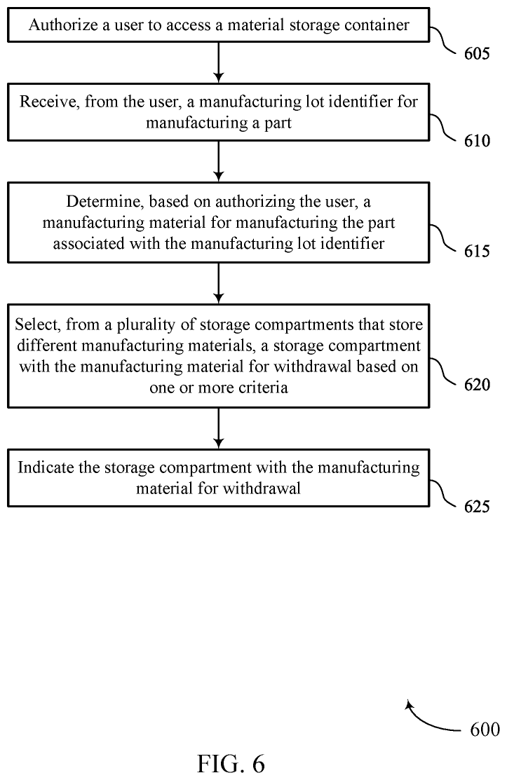

Features of the disclosure are initially described in the context of a material storage container and a system as described with reference to FIGS. 1 and 2. Features of the disclosure are described in the context process flows as described with reference to FIGS. 3 through 4. These and other features of the disclosure are further illustrated by and described with reference to an apparatus diagram and flowcharts that relate to a smart material storage container for manufacturing materials as described with reference to FIGS. 5 through 6.

FIG. 1 illustrates an example of a material storage container 100 for manufacturing materials in accordance with examples as disclosed herein. The material storage container 100 may include a quantity of storage compartments 105 (also referred to as pigeonholes, units, or other suitable terminology) that are configured to store materials such as manufacturing materials. Some storage compartments 105 may store different manufacturing materials and some storage compartments may store the same manufacturing material. For example, a first set of storage compartments 105 may store a first manufacturing material, a second set of storage compartments 105 may store a second manufacturing, and a third set of storage compartments 105 may store a third manufacturing material, and so on and so forth. The manufacturing materials stored in the storage compartments may be in the same or different quantities (e.g., amounts), may be deposited at the same or different times, and may have the same or different expiration dates.

The material storage container 100 may include one or more access-restricting mechanisms that prevent (e.g., when activated) and allow (e.g., when deactivated) access to the interior of the material storage container 100. For example, the material storage container 100 may include one or more doors 110 that prevent access to the material storage container 100 if closed (and locked) and that allow access to the material storage container if open. In some examples, the doors 110 may be locked via one or more locking mechanisms 115, such as a magnetic locking mechanism.

The material storage container 100 may include a display panel 120 that is configured to receive information from a user (e.g., a user identification) and for displaying information to the user. In some examples, the display panel 120 may be an interactive display panel (e.g., a graphical user interface). For example, the display panel 120 may receive a manufacturing lot identifier (ID) from a user, where a manufacturing lot ID identifies a part for manufacturing and the manufacturing materials for making the part, among other information. In some examples, the display panel 120 may display an indication of a storage compartment (e.g., a storage compartment number, the location of the storage compartment) that has manufacturing material for a part. In some examples, the display panel 120 may be removable.

In some examples, the material storage container 100 may include a radio frequency (RF) reader 125, such as an RF card reader, that is configured to receive information from a user. For example, the RF reader 125 may scan an employee badge to determine the identity of the user, which is turn can be used to determine the authorization status of the user. To illustrate, a user may have withdrawal privileges (e.g., be authorized to withdraw manufacturing material from the material storage container 100) and scrap return privileges (e.g., be authorized to deposit left-over manufacturing material for disposal) but may not have replenishment privileges (e.g., be authorized to deposit new manufacturing material for use by other users) or scrap removal privileges (e.g., be authorized to remove scrap material for disposal). In some examples, the material storage container 100 may record and track various information associated with a manufacturing material (e.g., the identity of the user who withdrew or deposited the manufacturing material, how long the manufacturing material was withdrawn, how much of the manufacturing material was used/returned).

In some examples, the material storage container 100 may include a code reader 130, such as a barcode reader or a QR-code reader. The code reader 130 may be configured to scan codes that indicate or are associated with information for a part (e.g., a manufacturing lot ID) or a manufacturing material (e.g., a material ID). In some examples, the material storage container 100 may use the information determined from a code to obtain (e.g., from local memory, from a management server, from the internet) more information related to the part or manufacturing material.

In some examples, the material storage container 100 may include an optical device 135 (e.g., a camera) that is configured to capture images or videos of users. In an example, the optical device 135 may be configured to record a user as the user operates the storage container 100. In an example, the optical device 135 may be configured to capture an image or video of a user in response to the material storage container 100 detecting unauthorized operation of the material storage container 100 (e.g., withdrawal of unauthorized manufacturing material, unauthorized deposit of manufacturing material).

In some examples, the material storage container 100 may include a processing unit, such as a processor, that processes information from various sources (e.g., components of the material storage container 100, a management server) and that controls various components and operations of the material storage container 100. The processing unit may also interact with and control a communication unit (e.g., a transceiver) of the material storage container 100 that is configured to communicate with external entities, such as a management server that is on-premises or off-premises. The processing unit may be positioned in a housing and may not be visible from the exterior of the material storage container 100.

In some examples, the storage compartments 105 may be coupled with one or more sensors (e.g., photoelectric sensors such as infrared (IR) sensors, cameras, pressure sensors) that are configured to detect the presence, absence, withdrawal, or deposit of manufacturing material. In some examples, the storage compartments 105 may be coupled with visual indicators, such as light-emitting components (e.g., light-emitting diodes (LEDs)) that can be activated to guide a user or to confirm a transaction. In some examples, the material storage container 100 may include an alarm component 140 that is configured to emit a signal (e.g., a visual signal, an auditory signal) that indicates unauthorized operation of the material storage container 100.

The material storage container 100 may support operation in various modes. In a replenishment mode, the material storage container 100 may assist an authorized user (e.g., a material handler) in depositing manufacturing material into the material storage container 100. For example, the user may input (e.g., via the display panel 120, via the code reader 130, via the RF reader 125) the material ID of the manufacturing material for deposit and the material storage container 100 may determine (and indicate) a storage compartment 105 for receipt of the manufacturing material. In some examples, the material storage container 100 may determine whether the material deposited into a storage compartment is the correct material. For instance, the material storage container 100 may compare an expected weight of the manufacturing material with an actual weight of the manufacturing material.

In a withdrawal mode, the material storage container 100 may assist authorized users in selecting appropriate manufacturing materials. For example, a user that is interested in making a particular part may not know the type or amount of manufacturing materials used for that part at that particular stage of manufacturing. In such a scenario, the user may input (e.g., via the display panel 120, via the code reader 130, via the RF reader 125) the manufacturing lot ID for the part and the material storage container 100 may determine the type(s) and/or quantity(s) of manufacturing material(s) used for the part. The material storage container 100 then indicates the type(s) of manufacturing material(s) (and, in some cases, the quantities of the types of manufacture material(s)) to the user. For example, the material storage container 100 may indicate a type of manufacturing material for the part (and for withdrawal by the user) by activating a light-emitting component associated with the storage compartment 105 that has the type of manufacturing material. Additionally or alternatively, the material storage container 100 may indicate the type of manufacturing material via the display panel 120, which may additionally or alternatively indicate the amount of the manufacturing material for the part.

In some examples, multiple storage compartments 105 may have the type of manufacturing material for a part. In such examples, the material storage container 100 may prioritize use of manufacturing material based on one or more criteria. For example, the material storage container 100 may select for withdrawal the storage compartment 105 that has the manufacturing material with the earliest expiration date, relative to the other similar materials in the material storage container 100. In a deposit-order based example (e.g., a first-in-first-out (FIFO) scheme), the material storage container 100 may select for withdrawal the storage compartment 105 that has the manufacturing material least recently deposited into the material storage container 100 (relative to the other manufacturing material of the same type). In a quantity-based example, the material storage container 100 may select for withdrawal the storage compartment 105 that has the largest quantity of the manufacturing material, or the storage compartment 105 that has quantity of the manufacturing material that is within a range of the quantity for the part.

In a scrap deposit mode, the material storage container 100 may assist an authorized user in depositing scrap material (e.g., excess material, unused material from a manufacturing process) in the material storage container 100 for retrieval by a material handler. For example, the user may input (e.g., via the display panel 120, via the code reader 130, via the RF reader 125) the material ID for the scrap material and the material storage container 100 may determine (and indicate) a storage compartment 105 for receipt of the scrap material. The material storage container 100 may tag the storage compartments with scrap material (e.g., to aid in removal of scrap material for disposal or return to a supply area, to avoid withdrawal of scrap material for manufacturing a part). Scrap material may be used or excess material that is left-over after various manufacturing processes are complete.

In a scrap withdrawal mode, the material storage container 100 may assist an authorized user (e.g., a material handler) in withdrawing scrap material from the material storage container 100. Scrap material may refer to excess material returned by a user and/or material with expired expiration dates. The material storage container 100 may auto-identify scrap material for disposal and indicate the storage compartments 105 with the scrap material.

Thus, the material storage container 100 may assist a user in withdrawing and depositing manufacturing materials.

FIG. 2 illustrates an example of a system 200 that supports a smart material storage container for manufacturing materials in accordance with examples as disclosed herein. The system 200 may include a quantity of material storage containers 205-1 through 205-N, which may be examples of the material storage container 100 described with reference to FIG. 1. The system 200 may also include a server 210, which may manage the storage containers 205 and perform inventory management. The server 210 may communicate (e.g., wirelessly or via one or more communication cables) with the material storage containers 205 and one or more computers 215. The computer 215 may connect to the server 210 to retrieve information (e.g., inventory information), to override the server 210 if useful, or to perform software upgrades.

The server 210 may communicate with the material storage containers 205 to track the use, inventory, and lifecycle of the manufacturing materials stored in the material storage units. For example, the server 210 may track which user withdraws a manufacturing material, for which part, and how much scrap material the user returns. The server 210 may also monitor the quantity of different types of manufacturing material. If a quantity of a type of manufacturing material falls below a threshold (e.g., a static threshold, a predicted threshold), the server 210 may alert a user (e.g., via an alert communicated to a computer 215). The server 210 may also monitor the quantity of manufacturing material in a warehouse for replenishing the manufacturing materials in the material storage containers 205. If the total quantity of a manufacturing material stored in the material storage containers falls below a threshold level, the server 210 may generate a request for transfer of the manufacturing material from the warehouse to the material storage containers 205.

So, the server 210 may provide intelligent stock replenishment for the overall system, and may include analytic capabilities (e.g., compliance, consumption analysis, anomaly analysis), predictive capabilities (e.g., predict when lot IDs will arrive at a given process step, estimate the type and quantity manufacturing material for the lot IDs), and monitoring capabilities (e.g., check-in and check-out manufacturing material from the supply area).

In some examples, the server 210 may coordinate material withdrawal from the material storage containers 205. For example, if a manufacturing material associated with manufacturing lot ID is unavailable at a first material storage container 205, the first material storage container 205 may transmit an indication of the unavailability to the server 210. The server 210 may check an inventory database and determine that a second material storage container 205 has the manufacturing material in stock (and in the requisite quantity). The server 210 may then communicate an indication of the second material storage container 205 to the first material storage container 205 so that the first material storage container 205 can direct the user to the second material storage container 205 (e.g., by displaying an indication of the second material storage container 205).

In some examples, the server 210 may connect with one or more devices that provide information to the server. For example, the server 210 may connect with a material storage container 205 to receive information about the manufacturing lot ID or material ID input (e.g., scanned) by a user. As another example, the server 210 may connect with a surveillance system to receive information about a manufacturing lot ID that is in progress. As another example, the server 210 may connect with an Internet-of-Things (IOT) device that provides information about the balance material at a manufacturing machine. As another example, the server 210 may connect with a system about the availability of manufacturing material in stock (e.g., in a warehouse) for replenishment of the material storage containers 205. In some examples, the system may also provide user-related information about the users, and the credentials of the users, that access the manufacturing material in stock.

In some examples, the server 210 may include one or more sub-systems that control various aspects of the overall system 200. For example, the server 210 may include a central container control sub-system that serves as the centralized processing unit of the server 210 and that connects with, and coordinates the functions of, the material storage containers 205. Additionally or alternatively, the server 210 may include a data storage sub-system that acts as centralized storage for information associated with the material storage containers 205. The data storage sub-system may provide visibility between the material storage containers 205 (e.g., so that a user can be directed from a first material storage container 205 that does not have a requested manufacturing material to a second material storage container 205 that has the manufacturing material).

Additionally or alternatively, the server 210 may include a material return sub-system that automates the return of manufacturing material to a supply area. Additionally or alternatively, the server 210 may include a stock replenishment sub-system that predicts when lot IDs will arrive at a given process step and that estimates the types of manufacturing materials, and quantities, for the lot ID at the process step. Additionally or alternatively, the server 210 may include an analytic generation sub-system that automates data analytic tasks, such as those related to compliance, consumption analysis, anomaly analysis, and that provides insights to users via a user interface.

In some examples, a material storage container 205 may include one or more sub-systems that control various aspects of the material storage container 205. For example, a material storage container 205 may include a container control sub-system that serves as the core processing unit of the material storage container 205 and that coordinates the functions of the other sub-systems. Additionally or alternatively, a material storage container 205 may include a periphery sub-system that serves as a bridge between peripheral devices and the container control sub-system. Additionally or alternatively, a material storage container 205 may include an anomaly detection sub-system that detects anomalous (e.g., unauthorized) behavior of users and records information associated with anomalous behavior (e.g., events such as material withdrawal or deposit, user IDs). In some examples, the anomaly detection sub-system may notify the container control sub-system of a recommended response to an anomalous behavior.

Additionally or alternatively, the material storage container 205 may include an identification sub-system that works together with the container control system to retrieve relevant information related to a lot ID or material ID (e.g., via the central container control sub-system of the server 210). Additionally or alternatively, the material storage container 205 may include a user identification sub-system that identifies a user's credentials and authorization status.

FIG. 3 illustrates an example of a process flow 300 that supports a smart material storage container for manufacturing materials in accordance with examples as disclosed herein. The process flow 300 may be implemented by a material storage container such as a material storage container 100 or 205 as described with reference to FIGS. 1 and 2, respectively. The process flow 300 may be implemented by a material storage container to assist a user with withdrawing manufacturing material (e.g., manufacturing material for a lot ID, manufacturing material for disposal) from the material storage container.

At 305, the material storage container may receive user information, such as a name or credentials (e.g., user ID) for the user. The user information may be received via an input device such as the display panel 120, the RF reader 125, or the code reader 130. At 310, the material storage container may determine whether the user is authorized to access the material storage container based on the user information. In some examples, the operations at 310 may occur after 315, in which case the material storage container may determine whether the user is authorized for the selected type of transaction. If the user is not authorized to access the material storage container (or not authorized for the selected type of transaction), the material storage container may, at 313, trigger an alarm (e.g., activate the alarm component 140). The material storage container may additionally or alternatively display an error message to the user, capture an image of the user (e.g., via the optical device 135), record the activity and/or image of the user, or report the activity and/or image of the user to a management system (e.g., the server 210), among other options.

If, at 310, the user is determined to be an authorized user, the material storage container may proceed to 315 or 320 (depending on whether the operations at 310 occur before or after 315). At 315, the material storage container may receive transaction information about the type of transaction intended by the user. For example, the material storage container may receive an indication of a withdrawal mode in which one or more manufacturing material(s) for manufacturing a part are withdrawn, a scrap deposit mode in which one or more scrap manufacturing material(s) are deposited for future disposal, a scrap withdrawal mode in which one or more scrap manufacturing material(s) are withdrawn for disposal, or a replenish mode in which one or more manufacturing material(s) are deposited to re-stock the material storage container.

At 320, the material storage container may grant access to the interior of the material storage container based on the authorization status of the user and the type of transaction. For example, the material storage container may unlock or otherwise deactivate the locking mechanism 115 that restricts access to the interior of the material storage container if the user is an authorized user.

At 325, the material storage container may determine whether withdrawal of manufacturing material has occurred and is complete. For example, the material storage container may determine whether each of the manufacturing materials selected for withdrawal have been withdrawn by the user. If, at 325, the material storage container determines that withdrawal of the manufacturing material is complete, the material storage container may proceed to 360 and end the transaction. In some examples, the material storage container may check if access to the interior of the material storage container is secure (e.g., the material storage container may check if the door(s) to the material storage container are closed and locked) before ending the transaction. If access is not secure, the material storage container may proceed to 333.

If, at 325, the material storage container determines that withdrawal of the manufacturing material is not complete, the material storage container may proceed to 330. At 330, the material storage container may determine whether material has been inappropriately withdrawn from, or deposited within, the material storage container. If, at 330, the material storage container determines that material has been inappropriately withdrawn from, or deposited within, the material storage container, the material storage container may, at 333, trigger an alarm (e.g., activate the alarm component 140). The material storage container may additionally or alternatively display an error message to the user at 337, capture an image of the user (e.g., via the optical device 135), record the activity and/or image of the user, or report the activity and/or image of the user to a management system (e.g., the server 210), among other options. The error message may request that the user check the material withdrawn or deposited and perform corrective action (e.g., replace incorrectly withdrawn material, remove incorrectly deposited material). The material storage container may then receive confirmation from the user that the corrective action has been completed.

If, at 330, the material storage container determines that material has been inappropriately withdrawn from, or deposited within, the material storage container, the material storage container may proceed to 335. For example, the material storage container may determine that material has been inappropriately withdrawn from, or deposited within, the material storage container if the material storage container detects a change in material at the material storage container (e.g., withdrawal of a material, which should not occur until after the material for withdrawal is indicated at 340, or deposit of a material, which should not occur in the withdrawal mode). At 335, the material storage container may (if the material storage container is operating in the withdrawal mode) receive a manufacturing lot ID from the user. The manufacturing lot ID may be associated with a part for manufacture.

At 340, the material storage container may identify manufacturing material for withdrawal. If the material storage container is operating in the withdrawal mode, the material storage container may identify the manufacturing material for manufacturing the part based on the manufacturing lot ID for the part. In some examples, the material storage container may determine a process step for manufacturing the part (e.g., the current process step in the manufacturing process) based on the manufacturing lot ID for the part. In such an example, the manufacturing material for manufacturing the part may be identified based on the process step. The material storage container may determine the process step via an input from the user or via an indication of the process step received from another device, such as a managing system (e.g., the server 210), that is controlling or monitoring the manufacture of the part.

In some examples, the material storage container may transit an indication of the manufacturing lot ID to a managing system (e.g., the server 210) and receive an indication of the manufacturing material(s) for the part based on transmitting the indication. Alternatively, the material storage container may reference an internal database to determine the manufacturing material(s) for the part. In some examples, the material storage container may receive an indication of a process step for the part in response to transmitting the indication of the manufacturing lot ID, in which case the material storage container may identify the manufacturing material based on the process step. If the material storage container is operating in the scrap withdrawal mode, the material storage container may identify the manufacturing material for withdrawal based on the disposal status of the manufacturing material, based on the expiration date of the manufacturing material, or both.

At 345, the material storage container may indicate (e.g., via a light-emitting component, via the display panel) a storage compartment that contains the manufacturing material for withdrawal. If the material storage container is operating in the withdrawal mode, the material storage container may select the storage compartment based on an expiration date of the manufacturing material in the storage compartment relative to the expiration dates of the manufacturing material in other storage compartments of the material storage container: based on a FIFO scheme and the deposit-order of the manufacturing material into the various storage compartments: based on a quantity of the manufacturing material in the storage compartment relative to the quantities of the manufacturing material in the other storage compartments: or any combination thereof.

At 350, the material storage container may determine whether the user withdrew the correct manufacturing material. For example, the material storage container may determine whether the user withdrew material from the storage compartment indicated by the material storage container or a different storage compartment. If, at 350, it is determined that the user withdrew incorrect manufacturing material, the material storage container may, at 353, trigger an alarm (e.g., activate the alarm component 140). The material storage container may additionally or alternatively display an error message to the user at 337, capture an image of the user (e.g., via the optical device 135), record the activity and/or image of the user, or report the activity and/or image of the user to a management system (e.g., the server 210), among other options.

If, at 350, it is determined that the user withdrew the correct manufacturing material, the material storage container may proceed to 355 and determine if access to the interior of the material storage container is secure before returning to 325 or ending the transaction at 360. If access is not secure, the material storage container may proceed to 365.

At 365, the material storage container may determine whether material has been in inappropriately withdrawn from, or deposited within, the material storage container. For example, the material storage container may determine that material has been inappropriately withdrawn from, or deposited within, the material storage container if the material storage container detects a change in material at the material storage container (e.g., withdrawal of a material, which should not occur until after another material for withdrawal is indicated at 340, or deposit of a material, which should not occur in the withdrawal mode). If material has been inappropriately withdrawn from, or deposited within, the material storage container, the material storage container may, at 370, trigger an alarm (e.g., activate the alarm component 140). The material storage container may additionally or alternatively display an error message to the user at 337, capture an image of the user (e.g., via the optical device 135), record the activity and/or image of the user, or report the activity and/or image of the user to a management system (e.g., the server 210), among other options.

At 375, the material storage container may generate and display (or transmit) an audit request that prompts an authorized user (e.g., a material handler) to audit the contents of the material storage container and determine whether the user has performed the corrective action indicated at 337. In some examples, the request may indicate a timeframe for performing the audit (e.g., the request may indicate whether the audit should be performed immediately, within a threshold period of time, or during the next replenishment or withdrawal session of the material handler). If, at 380, the user indicates that the material storage container has passed the audit (e.g., all flagged materials are correctly withdrawn or deposited), the material storage container may proceed to 325. If, at 380, the user indicates that the material storage container has not passed the audit (e.g., one or more materials remains incorrectly withdrawn or deposited), the material storage container may proceed to 333.

Thus, the material storage container may facilitate the withdrawal of one or more manufacturing materials from the material storage container. Alternative examples of the foregoing may be implemented, where some operations are performed in a different order than described, are performed in parallel, or are not performed at all. In some cases, operations may include additional features not mentioned herein, or further operations may be added. Additionally, some operations may be performed multiple times or some combinations of operations may repeat or cycle.

FIG. 4 illustrates an example of a process flow 400 that supports a smart material storage container for manufacturing materials in accordance with examples as disclosed herein. The process flow 400 may be implemented by a material storage container such as a material storage container 100 or 205 as described with reference to FIGS. 1 and 2, respectively. The process flow 400 may be implemented by a material storage container to assist a user with depositing manufacturing material (e.g., scrap manufacturing material for disposal, new manufacturing material for use manufacturing a part) into the material storage container.

The process flow 400 may be similar to the process flow 300. However, among other variations, rather indicating a storage compartment with a manufacturing material for withdrawal (e.g., based on the manufacturing lot ID, based on the disposal status of the manufacturing material), the material storage container may indicate a storage compartment for deposition of a manufacturing material (e.g., based on the material ID, based on the inventory status of the manufacturing material).

At 405, the material storage container may receive user information, such as a name or credentials (e.g., user ID) for the user. The user information may be received via an input device such as the display panel 120, the RF reader 125, or the code reader 130. At 410, the material storage container may determine whether the user is authorized to access the material storage container based on the user information. In some examples, the operations at 410 may occur after 415, in which case the material storage container may determine whether the user is authorized for the selected type of transaction. If the user is not authorized to access the material storage container (or not authorized for the selected type of transaction), the material storage container may, at 413, trigger an alarm (e.g., activate the alarm component 140). The material storage container may additionally or alternatively display an error message to the user, capture an image of the user (e.g., via the optical device 135), record the activity and/or image of the user, or report the activity and/or image of the user to a management system (e.g., the server 210), among other options.

If, at 410, the user is determined to be an authorized user, the material storage container may proceed to 415 or 420 (depending on whether the operations at 410 occur before or after 415). At 415, the material storage container may receive transaction information about the type of transaction intended by the user. For example, the material storage container may receive an indication of a withdrawal mode in which one or more manufacturing material(s) for manufacturing a part are withdrawn, a scrap deposit mode in which one or more scrap manufacturing material(s) are deposited for future disposal, a scrap withdrawal mode in which one or more scrap manufacturing material(s) are withdrawn for disposal, or a replenish mode in which one or more manufacturing material(s) are deposited to re-stock the material storage container.

At 420, the material storage container may grant access to the interior of the material storage container based on the authorization status of the user and the type of transaction. For example, the material storage container may unlock or otherwise deactivate the locking mechanism 115 that restricts access to the interior of the material storage container if the user is an authorized user.

At 425, the material storage container may determine whether deposition of manufacturing material has occurred and is complete. For example, the material storage container may determine whether each of the manufacturing materials selected for deposit have been deposited by the user. If, at 425, the material storage container determines that deposition of the manufacturing material is complete, the material storage container may proceed to 460 and end the transaction. In some examples, the material storage container may check if access to the interior of the material storage container is secure (e.g., the material storage container may check if the door(s) to the material storage container are closed and locked) before ending the transaction. If access is not secure, the material storage container may proceed to 433.

If, at 425, the material storage container determines that deposition of the manufacturing material is not complete, the material storage container may proceed to 430. At 430, the material storage container may determine whether material has been inappropriately withdrawn from, or deposited within, the material storage container. If, at 430, the material storage container determines that material has been inappropriately withdrawn from, or deposited within, the material storage container, the material storage container may, at 433, trigger an alarm (e.g., activate the alarm component 140). The material storage container may additionally or alternatively display an error message to the user at 437, capture an image of the user (e.g., via the optical device 135), record the activity and/or image of the user, or report the activity and/or image of the user to a management system (e.g., the server 210), among other options. The error message may request that the user check the material withdrawn or deposited and perform corrective action (e.g., replace incorrectly withdrawn material, remove incorrectly deposited material). The material storage container may then receive confirmation from the user that the corrective action has been completed.

If, at 430, the material storage container determines that material has been inappropriately withdrawn from, or deposited within, the material storage container, the material storage container may proceed to 435. For example, the material storage container may determine that material has been inappropriately withdrawn from, or deposited within, the material storage container if the material storage container detects a change in material at the material storage container (e.g., deposit of a material, which should not occur until after the storage compartment for deposit is indicated at 445, or withdrawal of a material, which should not occur in the deposit mode). At 435, the material storage container may (if the material storage container is operating in the deposition mode) receive a material ID from the user. The material ID may identify a manufacturing material.

At 440, the material storage container may identify a storage compartment available for deposition of the manufacturing material associated with the material ID. If the material storage container is operating in the scrap deposit mode, the material storage container may, in some examples, identify the storage compartment based on the storage compartment already storing the same type of manufacturing material for disposal. If the material storage container is operating in the replenishment mode, the material storage container may identify the manufacturing material for withdrawal based on the storage compartment being empty.

At 445, the material storage container may indicate (e.g., via a light-emitting component, via the display panel) a storage compartment that is available for deposition of the manufacturing material.

At 450, the material storage container may determine whether the user deposited the manufacturing material into the correct storage compartment. If, at 450, it is determined that the user deposited the manufacturing material into the incorrect storage compartment, the material storage container may, at 453, trigger an alarm (e.g., activate the alarm component 140). The material storage container may additionally or alternatively display an error message to the user at 437, capture an image of the user (e.g., via the optical device 135), record the activity and/or image of the user, or report the activity and/or image of the user to a management system (e.g., the server 210), among other options.

If, at 450, it is determined that the user deposited the manufacturing material into the correct storage compartment, the material storage container may proceed to 455 and determine if access to the interior of the material storage container is secure before returning to 425 or ending the transaction at 460. If access is not secure, the material storage container may proceed to 465.

At 465, the material storage container may determine whether material has been inappropriately withdrawn from, or deposited within, the material storage container. For example, the material storage container may determine that material has been inappropriately withdrawn from, or deposited within, the material storage container if the material storage container detects a change in material at the material storage container (e.g., deposit of a material, which should not occur until after another storage compartment for deposit is indicated at 445, or withdrawal of a material, which should not occur in the deposit mode). If material has been inappropriately withdrawn from, or deposited within, the material storage container, the material storage container may, at 470, trigger an alarm (e.g., activate the alarm component 140). The material storage container may additionally or alternatively display an error message to the user at 437, capture an image of the user (e.g., via the optical device 135), record the activity and/or image of the user, or report the activity and/or image of the user to a management system (e.g., the server 210), among other options.

At 475, the material storage container may generate and display (or transmit) an audit request that prompts an authorized user (e.g., a material handler) to audit the contents of the material storage container and determine whether the user has performed the corrective action indicated at 437. In some examples, the request may indicate a timeframe for performing the audit (e.g., the request may indicate whether the audit should be performed immediately, within a threshold period of time, or during the next replenishment or withdrawal session of the material handler). If, at 480, the user indicates that the material storage container has passed the audit (e.g., all flagged materials are correctly withdrawn or deposited), the material storage container may proceed to 425. If, at 480, the user indicates that the material storage container has not passed the audit (e.g., one or more materials remains incorrectly withdrawn or deposited), the material storage container may proceed to 433.

Thus, the material storage container may facilitate the deposition of one or more manufacturing materials into the material storage container. Alternative examples of the foregoing may be implemented, where some operations are performed in a different order than described, are performed in parallel, or are not performed at all. In some cases, operations may include additional features not mentioned herein, or further operations may be added. Additionally, some operations may be performed multiple times or some combinations of operations may repeat or cycle.

FIG. 5 illustrates a block diagram 500 of a material storage container 520 that supports smart material storage container for manufacturing materials in accordance with examples as disclosed herein. The material storage container 520 may be an example of aspects of a material storage container as described with reference to FIGS. 1 through 4. The material storage container 520, or various components thereof, may be an example of means for performing various aspects of smart material storage container for manufacturing materials as described herein. For example, the material storage container 520 may include an authorization manager 525, a lot ID manager 530), a manufacturing material manager 535, a priority manager 540), an indication manager 545, an alarm manager 550), an access manager 555, a media manager 560), or any combination thereof. Each of these components may communicate, directly or indirectly, with one another (e.g., via one or more buses).

The authorization manager 525 may be configured as or otherwise support a means for authorizing a user to access a material storage container. The lot ID manager 530 may be configured as or otherwise support a means for receiving, from the user, a manufacturing lot identifier for manufacturing a part. The manufacturing material manager 535 may be configured as or otherwise support a means for determining, based on authorizing the user, a manufacturing material for manufacturing the part associated with the manufacturing lot identifier. The priority manager 540 may be configured as or otherwise support a means for selecting, from a plurality of storage compartments that store different manufacturing materials, a storage compartment with the manufacturing material for withdrawal based on one or more criteria. The indication manager 545 may be configured as or otherwise support a means for indicating the storage compartment with the manufacturing material for withdrawal.

In some examples, the manufacturing material manager 535 may be configured as or otherwise support a means for determining, based on the manufacturing lot identifier, a second manufacturing material for manufacturing the part. In some examples, the indication manager 545 may be configured as or otherwise support a means for indicating a second storage compartment that has the second manufacturing material for withdrawal.

In some examples, the manufacturing material manager 535 may be configured as or otherwise support a means for determining a second manufacturing material for disposal based on one or more disposal criteria. In some examples, the indication manager 545 may be configured as or otherwise support a means for indicating the storage compartment with the second manufacturing material for disposal.

In some examples, the manufacturing material manager 535 may be configured as or otherwise support a means for receiving a manufacturing material identifier for a second manufacturing material. In some examples, the priority manager 540 may be configured as or otherwise support a means for selecting, from a set of the plurality of storage compartments available to receive the second manufacturing material, a second storage compartment for depositing the second manufacturing material based on the manufacturing material identifier. In some examples, the indication manager 545 may be configured as or otherwise support a means for indicating the second storage compartment for depositing the second manufacturing material.

In some examples, the manufacturing material manager 535 may be configured as or otherwise support a means for determining, based on the manufacturing lot identifier, a second manufacturing material for manufacturing the part associated with the manufacturing lot identifier. In some examples, the indication manager 545 may be configured as or otherwise support a means for transmitting an indication that the second manufacturing material is absent from the material storage container.

In some examples, the manufacturing material manager 535 may be configured as or otherwise support a means for receiving, based on transmitting the indication, an indication of a second material storage container that has the second manufacturing material. In some examples, the indication manager 545 may be configured as or otherwise support a means for indicating the second material storage container to the user.

In some examples, the manufacturing material manager 535 may be configured as or otherwise support a means for receiving an indication of the manufacturing material based on transmitting the manufacturing lot identifier, where the manufacturing material is determined based on receiving the indication of the manufacturing material.

In some examples, the manufacturing material manager 535 may be configured as or otherwise support a means for detecting withdrawal of a second manufacturing material from a second storage compartment different than the first manufacturing material indicated for withdrawal based on sensor information from a sensor of the material storage container. In some examples, the alarm manager 550 may be configured as or otherwise support a means for triggering an alarm based on detecting withdrawal of the second manufacturing material.

In some examples, the media manager 560 may be configured as or otherwise support a means for capturing an image of the user based on detecting withdrawal of the second manufacturing material.

In some examples, the manufacturing material manager 535 may be configured as or otherwise support a means for detecting deposition of a second manufacturing material into a second storage compartment based on sensor information from a sensor of the material storage container. In some examples, the alarm manager 550 may be configured as or otherwise support a means for triggering an alarm based on detecting deposition of the second manufacturing material.

In some examples, the access manager 555 may be configured as or otherwise support a means for granting access to the material storage container based at least in part authorizing the user to access the material storage container.

In some examples, to support indicating the storage compartment, the indication manager 545 may be configured as or otherwise support a means for activating a light-emitting component associated with the storage compartment. In some examples, to support indicating the storage compartment, the indication manager 545 may be configured as or otherwise support a means for displaying an indication of the storage compartment on an electronic display.

In some examples, the one or more criteria includes an expiration date for the manufacturing material, an order in which the manufacturing material was deposited in the material storage container, a quantity of the manufacturing material in the storage compartment, or any combination thereof.

FIG. 6 illustrates a flowchart showing a method 600 that supports smart material storage container for manufacturing materials in accordance with examples as disclosed herein. The operations of method 600 may be implemented by a material storage container or its components as described herein. For example, the operations of method 600 may be performed by a material storage container as described with reference to FIGS. 1 through 5. In some examples, a material storage container may execute a set of instructions to control the functional elements of the device to perform the described functions. Additionally, or alternatively, the material storage container may perform aspects of the described functions using special-purpose hardware.

At 605, the method may include authorizing a user to access a material storage container. The operations of 605 may be performed in accordance with examples as disclosed herein. In some examples, aspects of the operations of 605 may be performed by an authorization manager 525 as described with reference to FIG. 5.

At 610, the method may include receiving, from the user, a manufacturing lot identifier for manufacturing a part. The operations of 610 may be performed in accordance with examples as disclosed herein. In some examples, aspects of the operations of 610 may be performed by a lot ID manager 530 as described with reference to FIG. 5.

At 615, the method may include determining, based on authorizing the user, a manufacturing material for manufacturing the part associated with the manufacturing lot identifier. The operations of 615 may be performed in accordance with examples as disclosed herein. In some examples, aspects of the operations of 615 may be performed by a manufacturing material manager 535 as described with reference to FIG. 5.

At 620, the method may include selecting, from a plurality of storage compartments that store different manufacturing materials, a storage compartment with the manufacturing material for withdrawal based on one or more criteria. The operations of 620 may be performed in accordance with examples as disclosed herein. In some examples, aspects of the operations of 620 may be performed by a priority manager 540 as described with reference to FIG. 5.

At 625, the method may include indicating the storage compartment with the manufacturing material for withdrawal. The operations of 625 may be performed in accordance with examples as disclosed herein. In some examples, aspects of the operations of 625 may be performed by an indication manager 545 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for authorizing a user to access a material storage container: receiving, from the user, a manufacturing lot identifier for manufacturing a part: determining, based on authorizing the user, a manufacturing material for manufacturing the part associated with the manufacturing lot identifier: selecting, from a plurality of storage compartments that store different manufacturing materials, a storage compartment with the manufacturing material for withdrawal based on one or more criteria: and indicating the storage compartment with the manufacturing material for withdrawal.
Aspect 2: The method, apparatus, or non-transitory computer-readable medium of aspect 1, further including operations, features, circuitry, logic, means, or instructions, or any combination thereof for determining, based on the manufacturing lot identifier, a second manufacturing material for manufacturing the part and indicating a second storage compartment that has the second manufacturing material for withdrawal.
Aspect 3: The method, apparatus, or non-transitory computer-readable medium of any of aspects 1 through 2, further including operations, features, circuitry, logic, means, or instructions, or any combination thereof for determining a second manufacturing material for disposal based on one or more disposal criteria and indicating the storage compartment with the second manufacturing material for disposal.
Aspect 4: The method, apparatus, or non-transitory computer-readable medium of any of aspects 1 through 3, further including operations, features, circuitry, logic, means, or instructions, or any combination thereof for receiving a manufacturing material identifier for a second manufacturing material: selecting, from a set of the plurality of storage compartments available to receive the second manufacturing material, a second storage compartment for depositing the second manufacturing material based on the manufacturing material identifier: and indicating the second storage compartment for depositing the second manufacturing material.
Aspect 5: The method, apparatus, or non-transitory computer-readable medium of any of aspects 1 through 4, further including operations, features, circuitry, logic, means, or instructions, or any combination thereof for determining, based on the manufacturing lot identifier, a second manufacturing material for manufacturing the part associated with the manufacturing lot identifier and transmitting an indication that the second manufacturing material is absent from the material storage container.
Aspect 6: The method, apparatus, or non-transitory computer-readable medium of aspect 5, further including operations, features, circuitry, logic, means, or instructions, or any combination thereof for receiving, based on transmitting the indication, an indication of a second material storage container that has the second manufacturing material and indicating the second material storage container to the user.
Aspect 7: The method, apparatus, or non-transitory computer-readable medium of any of aspects 1 through 6, further including operations, features, circuitry, logic, means, or instructions, or any combination thereof for receiving an indication of the manufacturing material based on transmitting the manufacturing lot identifier, where the manufacturing material is determined based on receiving the indication of the manufacturing material.
Aspect 8: The method, apparatus, or non-transitory computer-readable medium of any of aspects 1 through 7, further including operations, features, circuitry, logic, means, or instructions, or any combination thereof for detecting withdrawal of a second manufacturing material from a second storage compartment different than the first manufacturing material indicated for withdrawal based on sensor information from a sensor of the material storage container and triggering an alarm based on detecting withdrawal of the second manufacturing material.
Aspect 9: The method, apparatus, or non-transitory computer-readable medium of aspect 8, further including operations, features, circuitry, logic, means, or instructions, or any combination thereof for capturing an image of the user based on detecting withdrawal of the second manufacturing material.
Aspect 10: The method, apparatus, or non-transitory computer-readable medium of any of aspects 1 through 9, further including operations, features, circuitry, logic, means, or instructions, or any combination thereof for detecting deposition of a second manufacturing material into a second storage compartment based on sensor information from a sensor of the material storage container and triggering an alarm based on detecting deposition of the second manufacturing material.
Aspect 11: The method, apparatus, or non-transitory computer-readable medium of any of aspects 1 through 10, further including operations, features, circuitry, logic, means, or instructions, or any combination thereof for granting access to the material storage container based at least in part authorizing the user to access the material storage container.
Aspect 12: The method, apparatus, or non-transitory computer-readable medium of any of aspects 1 through 11, where indicating the storage compartment includes operations, features, circuitry, logic, means, or instructions, or any combination thereof for activating a light-emitting component associated with the storage compartment and displaying an indication of the storage compartment on an electronic display.
Aspect 13: The method, apparatus, or non-transitory computer-readable medium of any of aspects 1 through 12, where the one or more criteria includes an expiration date for the manufacturing material, an order in which the manufacturing material was deposited in the material storage container, a quantity of the manufacturing material in the storage compartment, or any combination thereof.

It should be noted that the methods described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 14: A material storage container, including: a plurality of storage compartments that store different manufacturing materials: and a processor configured to cause the material storage container to: authorize a user to access the material storage container: receiving, from the user, a manufacturing lot identifier for manufacturing a part; determine, based on authorizing the user, a manufacturing material for manufacturing the part associated with the manufacturing lot identifier: select, from the plurality of storage compartments, a storage compartment with the manufacturing material for withdrawal based on one or more criteria: and indicate the storage compartment with the manufacturing material for withdrawal.
Aspect 15: The material storage container of aspect 14, where the processor is further configured to cause the material storage container to: determine, based on the manufacturing lot identifier, a second manufacturing material for manufacturing the part: and indicate a second storage compartment that has the second manufacturing material for withdrawal.
Aspect 16: The material storage container of any of aspects 14 through 15, where the processor is further configured to cause the material storage container to: determine a second manufacturing material for disposal based on one or more disposal criteria: and indicate the storage compartment with the second manufacturing material for disposal.
Aspect 17: The material storage container of any of aspects 14 through 16, where the processor is further configured to cause the material storage container to: receive a manufacturing material identifier for a second manufacturing material: select, from a set of the plurality of storage compartments available to receive the second manufacturing material, a second storage compartment for depositing the second manufacturing material based on the manufacturing material identifier: and indicate the second storage compartment for depositing the second manufacturing material.
Aspect 18: The material storage container of any of aspects 14 through 17, where the processor is further configured to cause the material storage container to: determine, based on the manufacturing lot identifier, a second manufacturing material for manufacturing the part associated with the manufacturing lot identifier: and transmit an indication that the second manufacturing material is absent from the material storage container.
Aspect 19: The material storage container of aspect 18, where the processor is further configured to cause the material storage container to: receive, based on transmitting the indication, an indication of a second material storage container that has the second manufacturing material: and indicate the second material storage container to the user.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal: however, the signal may represent a bus of signals, where the bus may have a variety of bit widths.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
authorizing a user to access a material storage container;
receiving, from the user, a manufacturing lot identifier for manufacturing a part;
determining, based on authorizing the user, a manufacturing material for manufacturing the part associated with the manufacturing lot identifier;
selecting, from a plurality of storage compartments storing different manufacturing materials, a storage compartment with the manufacturing material for withdrawal based on one or more criteria; and
indicating the storage compartment with the manufacturing material for withdrawal.

2. The method of claim 1, further comprising:
determining, based on the manufacturing lot identifier, a second manufacturing material for manufacturing the part; and
indicating a second storage compartment that has the second manufacturing material for withdrawal.

3. The method of claim 1, further comprising:
determining a second manufacturing material for disposal based on one or more disposal criteria; and
indicating the storage compartment with the second manufacturing material for disposal.

4. The method of claim 1, further comprising:
receiving a manufacturing material identifier for a second manufacturing material;
selecting, from a set of the plurality of storage compartments available to receive the second manufacturing material, a second storage compartment for depositing the second manufacturing material based on the manufacturing material identifier; and
indicating the second storage compartment for depositing the second manufacturing material.

5. The method of claim 1, further comprising:
determining, based on the manufacturing lot identifier, a second manufacturing material for manufacturing the part associated with the manufacturing lot identifier; and
transmitting an indication that the second manufacturing material is absent from the material storage container.

6. The method of claim 5, further comprising:
receiving, based on transmitting the indication, an indication of a second material storage container that has the second manufacturing material; and
indicating the second material storage container to the user.

7. The method of claim 1, further comprising:
receiving an indication of the manufacturing material based on transmitting the manufacturing lot identifier, wherein the manufacturing material is determined based on receiving the indication of the manufacturing material.

8. The method of claim 1, further comprising:
detecting withdrawal of a second manufacturing material from a second storage compartment different than the manufacturing material indicated for withdrawal based on sensor information from a sensor of the material storage container; and
triggering an alarm based on detecting withdrawal of the second manufacturing material.

9. The method of claim 8, further comprising:
capturing an image of the user based on detecting withdrawal of the second manufacturing material.

10. The method of claim 1, further comprising:
detecting deposition of a second manufacturing material into a second storage compartment based on sensor information from a sensor of the material storage container; and
triggering an alarm based on detecting deposition of the second manufacturing material.

11. The method of claim 1, further comprising:
granting access to the material storage container based at least in part authorizing the user to access the material storage container.

12. The method of claim 1, wherein indicating the storage compartment comprises:
activating a light-emitting component associated with the storage compartment; or
displaying an indication of the storage compartment on an electronic display.

13. The method of claim 1, wherein the one or more criteria comprises an expiration date for the manufacturing material, an order in which the manufacturing material was deposited in the material storage container, a quantity of the manufacturing material in the storage compartment, or any combination thereof.

14. A material storage container, comprising:
a plurality of storage compartments that store different manufacturing materials; and
a processor configured to cause the material storage container to:
authorize a user to access the material storage container;
receiving, from the user, a manufacturing lot identifier for manufacturing a part;
determine, based on authorizing the user, a manufacturing material for manufacturing the part associated with the manufacturing lot identifier;
select, from the plurality of storage compartments, a storage compartment with the manufacturing material for withdrawal based on one or more criteria; and
indicate the storage compartment with the manufacturing material for withdrawal.

15. The material storage container of claim 14, wherein the processor is further configured to cause the material storage container to:
determine, based on the manufacturing lot identifier, a second manufacturing material for manufacturing the part; and
indicate a second storage compartment that has the second manufacturing material for withdrawal.

16. The material storage container of claim 14, wherein the processor is further configured to cause the material storage container to:
determine a second manufacturing material for disposal based on one or more disposal criteria; and
indicate the storage compartment with the second manufacturing material for disposal.

17. The material storage container of claim 14, wherein the processor is further configured to cause the material storage container to:
receive a manufacturing material identifier for a second manufacturing material;
select, from a set of the plurality of storage compartments available to receive the second manufacturing material, a second storage compartment for depositing the second manufacturing material based on the manufacturing material identifier; and
indicate the second storage compartment for depositing the second manufacturing material.

18. The material storage container of claim 14, wherein the processor is further configured to cause the material storage container to:
determine, based on the manufacturing lot identifier, a second manufacturing material for manufacturing the part associated with the manufacturing lot identifier; and
transmit an indication that the second manufacturing material is absent from the material storage container.

19. The material storage container of claim 18, wherein the processor is further configured to cause the material storage container to:
receive, based on transmitting the indication, an indication of a second material storage container that has the second manufacturing material; and
indicate the second material storage container to the user.

20. A non-transitory computer-readable medium storing code comprising instructions which, when executed by a processor of a material storage container, cause the material storage container to:
authorize a user to access the material storage container;
receive, from the user, a manufacturing lot identifier for manufacturing a part;
determine, based on authorizing the user, a manufacturing material for manufacturing the part associated with the manufacturing lot identifier;
select, from a plurality of storage compartments storing different manufacturing materials, a storage compartment with the manufacturing material for withdrawal based on one or more criteria; and
indicate the storage compartment with the manufacturing material for withdrawal.
